(19) United States
(12) Patent Application Publication
(10) Pub. No.: US 2021/0225570 A1
(43) Pub. Date: Jul. 22, 2021

(54) LAMINATED CORE

(71) Applicant: TOYOTA JIDOSHA KABUSHIKI KAISHA, Toyota-shi (JP)

(72) Inventors: Shigeru KONDA, Kariya-shi (JP); Yukihiro YOSHIDA, Akita-shi (JP)

(73) Assignee: TOYOTA JIDOSHA KABUSHIKI KAISHA, Toyota-shi (JP)

(21) Appl. No.: 17/120,456

(22) Filed: Dec. 14, 2020

(30) Foreign Application Priority Data
Jan. 16, 2020 (JP) 2020-005298

(51) Int. Cl. H01F 3/02; H01F 41/02

(52) U.S. Cl. CPC H01F 3/02; H01F 41/0233

(57) ABSTRACT

A laminated core that enables reducing an eddy-current loss while reducing a decrease in space factor. The laminated core includes laminated soft magnetic strips with at least one patterned soft magnetic strip having a first surface. The first surface includes at least one protruding portion having a top surface. The top surface of the at least one protruding portion contacts a surface opposed to the first surface. The surface opposed to the first surface is included in a surface of one of the soft magnetic strips, which is adjacent to the at least one patterned soft magnetic strip. A gap is present between the surface opposed to the first surface and a part of the first surface, the part being other than the top surface

### CROSS REFERENCE TO RELATED APPLICATIONS

The present application claims priority from Japanese patent application JP 2020-005298 filed on Jan. 16, 2020, the entire content of which is hereby incorporated by reference into this application.

### BACKGROUND

### Technical Field

The present disclosure relates to a laminated core.

### Background Art

To improve energy efficiency of machines such as a hybrid vehicle and an electric vehicle, a reduction in eddy-current loss of a core of a motor used for these machines is required. Therefore, to reduce the eddy-current loss, a laminated core in which a plurality of electromagnetic steel strips are laminated has been used as the core of the motor.

JP H08-162335 A discloses a core constituted by laminating steel plates having surfaces on which oxide films are formed. According to JP H08-162335 A, the oxide films increase a contact resistance between the steel plates, and this reduces an eddy current flowing through the core. JP 2012-511628 T discloses a method for manufacturing a steel strip in which an iron oxide coating is formed.

JP 2019-188751 A discloses an electromagnetic steel sheet that can be used as, for example, a motor or a transformer core material and includes a coat containing an organic material on an outermost surface of one surface and a coat containing a low-melting-point glass on at least a part of an outermost surface of the other surface.

JP 2008-036671 A discloses a method for crimping electromagnetic steel sheets used to manufacture a laminated electromagnetic steel sheet. The method described in JP 2008-036671 A avoids a breakage of an insulation film formed on an electromagnetic steel sheet surface to maintain an insulating property between the electromagnetic steel sheets and reduce an iron loss.

JP 2000-282191 A discloses a steel plate for laminated core having a surface roughness from 0.6 to 4.0 μm applied to a laminated core of an alternator and a starter motor.

### SUMMARY

To further reduce the eddy-current loss, a development of a laminated core including electromagnetic steel strips having a further small thickness has been proceeded. However, the reduction in thickness of the electromagnetic steel strip decreases a volume proportion of electromagnetic steel in the core, namely, a space factor, resulting in decrease in an output from the motor.

The present disclosure provides a laminated core that enables reducing an eddy-current loss while reducing a decrease in space factor.

A laminated core according to one aspect of the present disclosure comprises a plurality of laminated soft magnetic strips. The plurality of soft magnetic strips include at least one patterned soft magnetic strip. The at least one patterned soft magnetic strip has a first surface. The first surface includes at least one protruding portion having a top surface. The top surface of the at least one protruding portion contacts a surface opposed to the first surface. The surface opposed to the first surface is included in a surface of one of the plurality of soft magnetic strips. The one of the plurality of soft magnetic strips is adjacent to the at least one patterned soft magnetic strip. A gap is present between the surface opposed to the first surface and a part of the first surface, the part being other than the top surface.

The laminated core according to the present disclosure enables reducing an eddy-current loss while reducing a decrease in space factor.

### BRIEF DESCRIPTION OF THE DRAWINGS

FIG. 1 is a schematic perspective view of a laminated core according to a first embodiment:

FIG. 2 is a drawing schematically illustrating an example of a first surface of a patterned soft magnetic strip included in the laminated core according to the first embodiment:

FIG. 3 is a drawing schematically illustrating an example of a cross-section of the laminated core according to the first embodiment, the cross-section taken along the line A-A in FIG. 2;

FIG. 4 is a drawing schematically illustrating an example of a cross-section of the laminated core according to the first embodiment, the cross-section taken along the line B-B in FIG. 2:

FIG. 5 is a drawing schematically illustrating an example of a first surface of a patterned soft magnetic strip included in a laminated core according to a second embodiment:

FIG. 6 is a drawing schematically illustrating an example of a cross-section of the laminated core according to the second embodiment, the cross-section taken along the line C-C in FIG. 5;

FIG. 7 is a drawing schematically illustrating an example of a first surface of a patterned soft magnetic strip included in a laminated core according to a third embodiment;

FIG. 8 is a drawing schematically illustrating an example of a cross-section of the laminated core according to the third embodiment, the cross-section taken along the line D-D in FIG. 7:

FIG. 9 is a drawing schematically illustrating an example of a first surface of a patterned soft magnetic strip included in a laminated core according to a modified embodiment;

FIG. 10 is a drawing schematically illustrating an example of a first surface of a patterned soft magnetic strip included in a laminated core according to a modified embodiment;

FIG. 11 is a drawing schematically illustrating an example of a first surface of a patterned soft magnetic strip included in a laminated core according to a modified embodiment:

FIG. 12 is a graph showing a calculation result of eddy-current losses in a laminated core of Calculation Example 1:

FIG. 13 is a graph showing a calculation result of eddy-current losses in a laminated core of Calculation Example 2; and

FIG. 14 is a graph showing a calculation result of eddy-current losses in a laminated core of Calculation Example 3.

### DETAILED DESCRIPTION

### First Embodiment

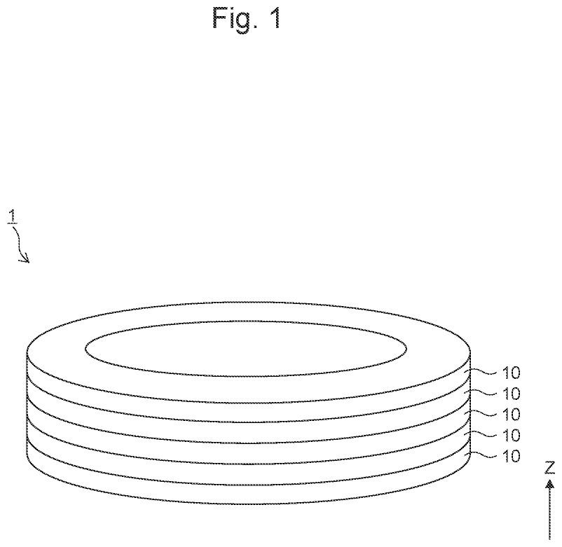

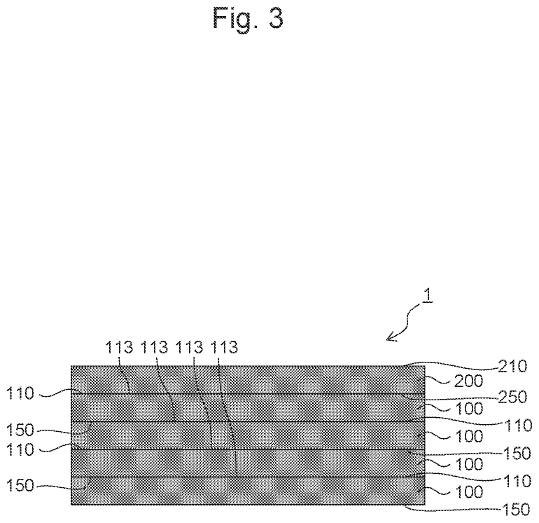

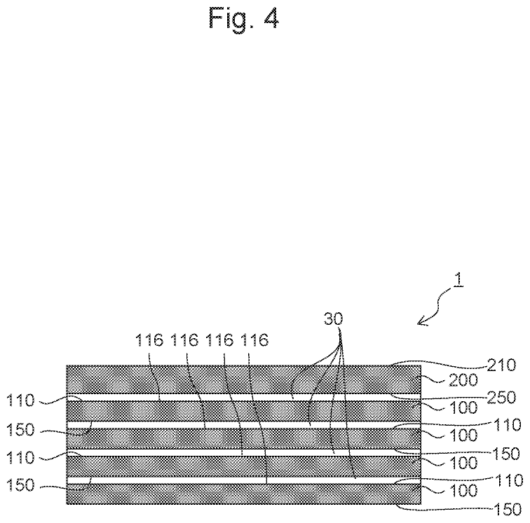

As illustrated in FIGS. 1 to 4, a laminated core 1 according to the first embodiment includes a plurality of laminated soft magnetic strips 10.

The soft magnetic strip 10 is a plate-shaped or a foil-shaped member made of a soft magnetic material. The soft magnetic strip 10 may have a thickness from several nm to 1 mm, from 1 μm to 1 mm in some embodiments, and from 10 μm to 20 μm in some embodiments. Examples of the soft magnetic material include a material containing at least one kind of a magnetic metal selected from the group consisting of Fe, Co, and Ni and at least one kind of a non-magnetic metal selected from the group consisting of B. C. P, Al. Si. Ti, V, Cr, Mn, Cu, Y, Zr, Nb, Mo, Hf, Ta, and W but the soft magnetic material is not limited to these materials. The soft magnetic material may be amorphous or crystalline. For example, as the soft magnetic strip 10, an electromagnetic steel sheet (silicon steel plate), an amorphous alloy ribbon, and a nanocrystalline alloy ribbon can be used.

The soft magnetic strip 10 has a ring shape in plan view in the laminating direction (Z direction in FIG. 1) of the soft magnetic strips 10. While the soft magnetic strip 10 illustrated in FIG. 1 has the circular ring shape, the shape is not limited to this shape, and the soft magnetic strip 10 may have any ring shape, such as a rectangular ring shape.

The number of the soft magnetic strips 10 may be appropriately determined according to the material of the soft magnetic strip 10 and the like so as to realize a motor having a desired torque.

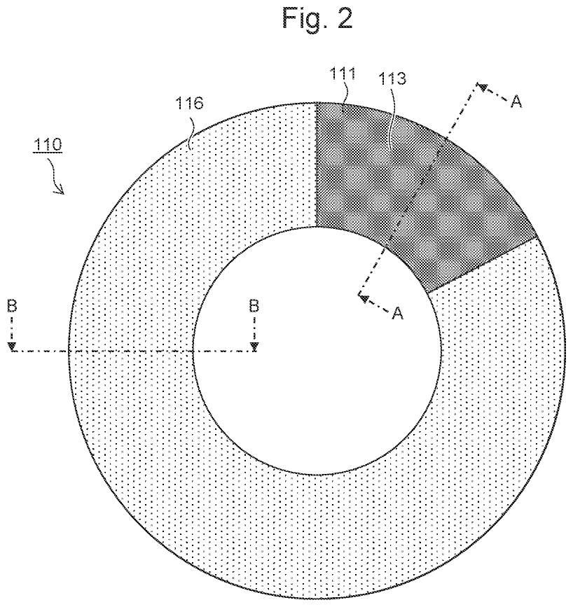

As illustrated in FIGS. 2 to 4, the soft magnetic strip 10 includes a plurality of patterned soft magnetic strips 100 and one unpattemed soft magnetic strip 200.

The patterned soft magnetic strip 100 has a first surface 110 and a second surface 150 as a surface opposite to the first surface 110.

The first surface 110 has a single protruding portion 111 having a top surface 113. Thus, the first surface 110 has an uneven pattern. In plan view in the laminating direction of the soft magnetic strips 10, the protruding portion 111 has a partial circular ring shape having an inner diameter and an outer diameter which are the same as an inner diameter and an outer diameter of the first surface 110, respectively.

In this application, a part other than the top surface 113 in the first surface 110 is appropriately referred to as a depressed surface 116. In the first embodiment, the first surface 110 is formed of a single top surface 113 and a single depressed surface 116. The top surface 113 has a partial circular ring shape having an inner diameter and an outer diameter which are the same as an inner diameter and an outer diameter of the first surface 110, respectively. Similarly, the depressed surface 116 also has a partial circular ring shape having an inner diameter and an outer diameter which are the same as the inner diameter and the outer diameter of the first surface 110, respectively.

In this application, a difference between an average value of distances from a reference surface perpendicular to the laminating direction of the soft magnetic strips 10 to points on the depressed surface 116 and an average value of distances from the reference surface to points on the top surface 113 is referred to as a height of the top surface 113. The height of the top surface 113 may be 0.01 times or less a thickness of the soft magnetic strip 10, and, for example, may be from 0.001 to 0.01 times the thickness of the soft magnetic strip 10. This allows the laminated core 1 to have a high space factor exceeding 99%. For example, the height of the top surface 113 may be in a range from 0.1 nm to 10 μm, from 1 nm to 10 μm in some embodiments, and from 10 nm to 200 nm in some embodiments. Note that, in this application, the height of the top surface 113 is appropriately also referred to as a height of the protruding portion 111 or a height of a gap 30 described later. The height of the top surface 113 is larger than the maximum height Sz of the depressed surface 116. Accordingly, a part excluding side surfaces of the protruding portion 111 in the depressed surface 116 does not have an intersection point or a contact point with an imaginary plane formed by extending the top surface 113. The maximum height Sz of the depressed surface 116 is a value representing a difference between the maximum value and the minimum value of the distance from the reference surface perpendicular to the laminating direction of the soft magnetic strips 10 to points on the depressed surface 116 (note that the side surfaces of the protruding portion 111 are excluded) and is measured by the method specified in ISO25178.

The top surface 113 and the depressed surface 116 each may have any surface roughness smaller than the height of the top surface 113, and, for example, may have an arithmetic mean surface roughness Sa 0.01 to 0.1 times the height of the top surface 113. For example, the top surface 113 and the depressed surface 116 each may have the arithmetic mean surface roughness Sa in a range from 0.001 nm to 0.1 μm. In this application, the arithmetic mean surface roughness Sa is measured by the method specified in ISO25178.

The second surface 150 needs not to have an uneven pattern. The second surface 150 may have any surface roughness smaller than the height of the top surface 113, and, for example, may have the arithmetic mean surface roughness Sa 0.01 to 0.1 times the height of the top surface 113. For example, the second surface 150 may have the arithmetic mean surface roughness Sa in a range from 0.001 nm to 0.1 μm.

The unpattemed soft magnetic strip 200 has a first surface 210 and a second surface 250 as a surface opposite to the first surface 210. The first surface 210 and the second surface 250 need not to have an uneven pattern. The first surface 210 and the second surface 250 each may have any surface roughness smaller than the height of the top surface 113, and, for example, may have the arithmetic mean surface roughness Sa 0.01 to 0.1 times the height of the top surface 113. For example, the first surface 210 and the second surface 250 may have the arithmetic mean surface roughness Sa in a range from 0.001 nm to 0.1 μm. As the unpatterned soft magnetic strip 200, a plate-shaped or a foil-shaped soft magnetic strip used for the conventional laminated core can be used.

In the laminated core 1 of the first embodiment, the plurality of patterned soft magnetic strips 100 and one unpattemed soft magnetic strip 200 are laminated in this order. The first surface 110 of the patterned soft magnetic strip 100 is opposed to the second surface 150 of the adjacent patterned soft magnetic strip 100 or the second surface 250 of the adjacent unpatterned soft magnetic strip 200. The top surface 113 of the first surface 110 of the patterned soft magnetic strip 100 contacts the second surface 150 of the adjacent patterned soft magnetic strip 100 or the second surface 250 of the adjacent unpattemed soft magnetic strip 200. The depressed surface 116 of the first surface 110 of the patterned soft magnetic strip 100 does not contact the second surface 150 of the adjacent patterned soft magnetic strip 100 or the second surface 250 of the adjacent unpatterned soft magnetic strip 200. That is, the gap 30 is present between the depressed surfaces 116 of the first surface 110 of the patterned soft magnetic strip 100 and the second surface 150 of the adjacent patterned soft magnetic strip 100, or between the depressed surfaces 116 of the first surface 110 of the patterned soft magnetic strip 100 and the second surface 250 of the adjacent unpattemed soft magnetic strip 200. Air may be present in the gap 30.

In the laminated core 1 of the first embodiment, in plan view in the laminating direction of the soft magnetic bands 10, the protruding portions 111 of all of the patterned soft magnetic bands 100 have the same shapes and are arranged at the same positions. That is, shapes and arrangements of the top surfaces 113 of all of the patterned soft magnetic strips 100 are the same, and shapes and arrangements of the depressed surfaces 116 of all of the patterned soft magnetic strips 100 are also the same.

Compared with the conventional laminated core in which an insulating layer is arranged in the whole interface between soft magnetic strips adjacent to one another, the laminated core 1 of the first embodiment in which the gap 30 is only partially present between the soft magnetic strips 10 adjacent to one another can have a higher space factor.

In the first embodiment, since the depressed surface 116 does not contact the adjacent soft magnetic strip 10, a flow of an eddy current from the soft magnetic strip 10 to the adjacent soft magnetic strip 10 through the depressed surface 116 is avoided. On the other hand, the top surface 113 contacts the surface of the adjacent soft magnetic strip 10, and therefore the eddy current possibly flows from the soft magnetic strip 10 to the adjacent soft magnetic strip 10 through the top surface 113. However, the inventors have found that, as described in calculation examples described later, appropriately designing areas and arrangements of the top surfaces 113 and the depressed surfaces 116 allows sufficiently reducing an eddy-current loss.

In the first embodiment, the top surface 113 may have the area larger than 0% and 20% or less of the area of the first surface 110. This allows sufficiently reducing the eddy-current loss in the motor.

In a case where the surface of the soft magnetic strip 10 in contact with the top surface 113 (that is, a second surface 150 of a patterned soft magnetic strip 100, the second surface 150 being opposed to a first surface 110 of another patterned soft magnetic strip 100 and these patterned soft magnetic strips 100 being adjacent to one another, or a second surface 250 of the unpattemed soft magnetic strip 200 adjacent to the patterned soft magnetic strip 100) has the predetermined arithmetic mean surface roughness Sa, especially the arithmetic mean surface roughness Sa 0.01 to 0.1 times the height of the top surface 113, for example, the arithmetic mean surface roughness Sa of 0.001 nm to 0.1 μm, only a part of the top surface 113 contacts the surface of the adjacent soft magnetic strip 10 since the top surface 113 of the patterned soft magnetic strip 100 is in point contact or line contact with the surface of the adjacent soft magnetic strip 10. This further decreases the contacted area between the top surface 113 and the surface of the adjacent soft magnetic strip 10, thereby allowing further reduction of the eddy-current loss.

### Second Embodiment

The laminated core 1 of the second embodiment differs from the laminated core 1 of the first embodiment in the number and positions of the protruding portions 111 disposed on the first surface 110 of the patterned soft magnetic strip 100. In other respects, the second embodiment is similar to the first embodiment and therefore the description is omitted.

The first surface 110 of the patterned soft magnetic strip 100 includes the plurality of protruding portions 111 each having the top surface 113. Thus, the first surface 110 has an uneven pattern. In plan view in the laminating direction of the soft magnetic strips 10, the plurality of protruding portions 111 have circular ring shapes concentric with the first surface 110.

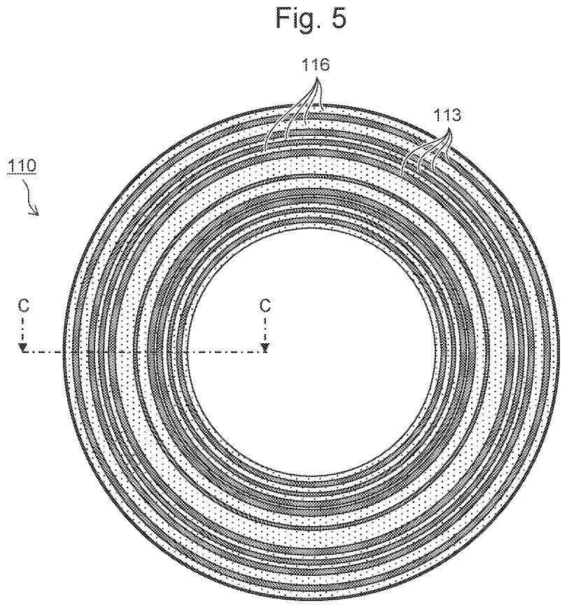

In the second embodiment, the first surface 110 is formed of the plurality of top surfaces 113 and the plurality of depressed surfaces 116. As illustrated in FIG. 5, the top surfaces 113 have circular ring shapes concentric with the first surface 110. The depressed surfaces 116 also have circular ring shapes concentric with the first surface 110.

The number of protruding portions 111 in each patterned soft magnetic strip 100 and an inner diameter and an outer diameter of each of the plurality of protruding portions 111 are set to be irregular so as to be different from those of the other patterned soft magnetic strips 100. That is, the numbers of the top surfaces 113 and the depressed surfaces 116 in each patterned soft magnetic strip 100 and the respective inner diameters and outer diameters of the plurality of top surfaces 113 and the plurality of depressed surfaces 116 are set to be irregular so as to be different from those of the other patterned soft magnetic strips 100. In this case, in plan view in the laminating direction of the soft magnetic strips 10, every patterned soft magnetic strip 100 includes the top surfaces 113 and the depressed surfaces 116 arranged at positions different from positions of the top surfaces 113 and the depressed surfaces 116 of a patterned soft magnetic strip 100 adjacent to such a patterned soft magnetic strip 100. Especially, in plan view in the laminating direction of the soft magnetic strips 10, every patterned soft magnetic strip 100 may have the top surfaces 113 arranged at the positions different from positions of the top surfaces 113 of any other patterned soft magnetic strip 100 and may have the depressed surfaces 116 arranged at the positions different from positions of the depressed surfaces 116 of any other patterned soft magnetic strip 100.

The laminated core 1 of the second embodiment in which the gaps 30 are partially present between the soft magnetic strips 10 adjacent to one another can have a higher space factor compared with the conventional laminated core in which an insulating layer is arranged in the whole interface between soft magnetic strips adjacent to one another.

In the second embodiment, since the depressed surfaces 116 do not contact the adjacent soft magnetic strip 10, a flow of the eddy current from one soft magnetic strip 10 to the adjacent soft magnetic strip 10 through the depressed surfaces 116 is avoided. On the other hand, the top surfaces 113 contact the surface of the adjacent soft magnetic strip 10, and therefore the eddy current possibly flows from the soft magnetic strip 10 to the adjacent soft magnetic strip 10 through the top surfaces 113. However, the inventors have found that, as described in the calculation examples described later, appropriately designing the areas and the arrangements of the top surfaces 113 and the depressed surfaces 116 allows sufficiently reducing the eddy-current loss.

Furthermore, in the laminated core 1 of the second embodiment, the plurality of protruding portions 111 are disposed on the first surface 110 of each patterned soft magnetic strip 10, and the top surfaces 113 on the first surfaces 110 of the patterned soft magnetic strips 100 adjacent to one another are arranged at mutually different positions in plan view in the laminating direction of the soft magnetic strips 10. As described in the calculation examples described later, the total area of the depressed surfaces 116 (that is, the total area of the gaps 30) required to reduce the eddy-current loss in the laminated core 1 of the second embodiment is smaller than the total area of the depressed surface 116 required to reduce the eddy-current loss in the laminated core 1 of the first embodiment in which a single protruding portion 111 is disposed in each patterned soft magnetic strip 100 and the shapes and the arrangements of the protruding portions 111 on the first surfaces 110 of the patterned soft magnetic strips 100 adjacent to one another are the same in plan view in the laminating direction of the soft magnetic strips 10. Therefore, the laminated core 1 of the second embodiment allows sufficiently reducing the eddy-current loss while further reducing the proportion of the gaps 30 in the laminated core 1 and achieving the further high space factor.

The inventors have considered the reason for this as follows. As long as the total area of the top surfaces 113 in the first surface 110 is the same, each top surface 113 of the first surface 110 including the plurality of top surfaces 113 has an area smaller than that of the top surface 113 of the first surface 110 having a single top surface 113. Therefore, the first surface 110 including the plurality of top surfaces 113 has regions through which the eddy current flows in the laminating direction of the soft magnetic strips 10, each of the regions having an area smaller than the area of the region through which the eddy current flows in the laminating direction of the soft magnetic strips 10, the region included in the first surface 110 having a single top surface 113. This reduces the eddy current generated in the laminated core 1. Furthermore, in plan view in the laminating direction of the soft magnetic strips 10, the difference in the arrangements of the plurality of top surfaces 113 in the patterned soft magnetic strips 100 adjacent to one another reduces the flow of the eddy current passing through the plurality of soft magnetic strips 10 in the laminating direction of the soft magnetic strips 10. This reduces the eddy current generated in the laminated core 1.

In the second embodiment, the top surfaces 113 may have the area larger than 0% and 60% or less of the area of the first surface 110. This allows sufficiently reducing the eddy-current loss in the motor.

### Third Embodiment

The laminated core 1 of the third embodiment differs from the laminated core 1 of the second embodiment in that the protruding portions 1l1 disposed on the first surface 110 of the patterned soft magnetic strip 100 are regularly arranged at a constant pitch. In other respects, the third embodiment is similar to the second embodiment and therefore the description is omitted.

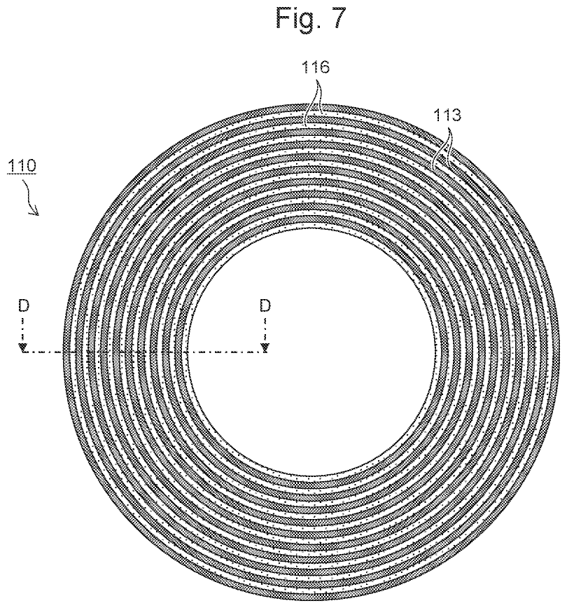

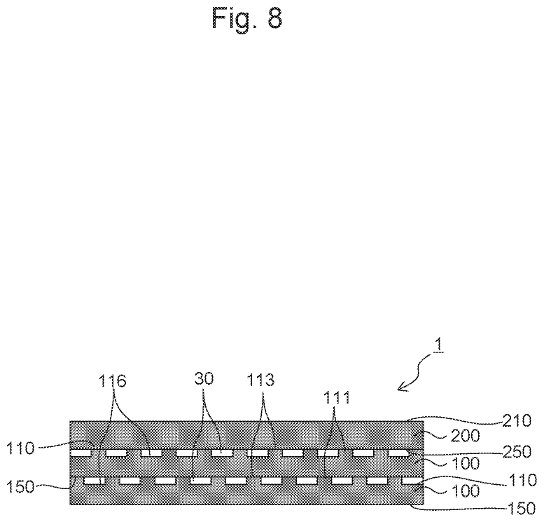

As illustrated in FIG. 7, the first surface 110 of the patterned soft magnetic strip 100 is formed of the plurality of top surfaces 113 and the plurality of depressed surfaces 116. The top surfaces 113 have circular ring shapes concentric with the first surface 110. The depressed surfaces 116 also have circular ring shapes concentric with the first surface 110. The top surfaces 113 and the depressed surfaces 116 are regularly arranged in alternation at a constant pitch from an inner periphery to an outer periphery of the first surface 110. As illustrated in FIG. 8, the numbers and pitches of the top surfaces 113 and the depressed surfaces 116 in the respective patterned soft magnetic strips 100 are the same.

In plan view in the laminating direction of the soft magnetic strips 10, phases of the top surfaces 113 and the depressed surfaces 116 in the patterned soft magnetic strips 100 adjacent to one another may be matched or may be shifted. By shifting the phases, an area of regions included in the top surfaces 113 of the patterned soft magnetic strip 100, the regions overlapping with the top surfaces 113 of the adjacent patterned soft magnetic strip 100 in plan view in the laminating direction of the soft magnetic strips 10, can be reduced. This reduces the flow of the eddy current passing through the plurality of soft magnetic strips 10 in the laminating direction of the soft magnetic strips 10 and the eddy current generated in the laminated core 1 can be reduced.

For example, the total area of the regions included in the top surfaces 113 of one of the patterned soft magnetic strips 100 adjacent to one another, the regions overlapping with the top surfaces 113 of the other of the patterned soft magnetic strips 100 adjacent to one another in plan view in the laminating direction of the soft magnetic strips 10, may be from 0 to 10% of the area of the first surface 110 or may be from 0 to 25% of the total area of the top surfaces 113 in one patterned soft magnetic strip 100.

The above-described laminated cores according to the embodiments can be used as the core of the motor embedded into various kinds of machinery, for example, a vehicle, such as a hybrid vehicle and an electric vehicle.

<Method for Manufacturing Laminated Core>

The above-described laminated cores according to the embodiments may be manufactured by any method. For example, the laminated core can be manufactured by manufacturing a laminated body in which a plurality of patterned soft magnetic strips and an unpattemed soft magnetic strip are laminated in this order and joining the soft magnetic strips in the laminated body by any method used in the technical field, such as welding.

An example of a method for manufacturing plate-shaped patterned soft magnetic strips will be described. First, a first roll having a side surface with an uneven pattern that is an inversion of an uneven pattern of the patterned soft magnetic strip to be manufactured is prepared. The uneven pattern can be manufacturing by, for example, laser processing. Additionally, a second roll is prepared. An uneven pattern needs not to be formed on a side surface of the second roll. A texture processing (such as dull finish) may be performed on the side surface of the second roll. A plate of a soft magnetic material, for example, an electromagnetic steel sheet is passed through between the first roll and the second roll to be pressed. Thus, the uneven pattern of the first roll is transferred to the plate of the soft magnetic material, and the plate-shaped patterned soft magnetic strip with the uneven pattern formed on the first surface is manufactured. The texture on the side surface of the second roll may be transferred on the second surface of the manufactured patterned soft magnetic strip.

An example of the method for manufacturing the foil-shaped patterned soft magnetic strip will be described. A roll having a side surface with an uneven pattern that is an inversion of an uneven pattern of a patterned soft magnetic strip to be manufactured and including a cooling mechanism is prepared. While the roll is rotated, a melt of the soft magnetic material is applied over the side surface of the roll. The melt is cooled on the side surface of the roll to turn into a solid. The solidified soft magnetic material is removed from the roll, thereby obtaining the foil-shaped patterned soft magnetic strip having a first surface formed with the uneven pattern. A surface roughness of the second surface can be controlled by a temperature of the roll, a drop speed of the melt, and a cooling gas during the application of the melt over the roll, and the like.

### Modified Embodiment

While the embodiments of the present disclosure have been described in detail above, the present disclosure is not limited thereto, and can be subjected to various kinds of changes in design without departing from the spirit of the present disclosure described in the claims.

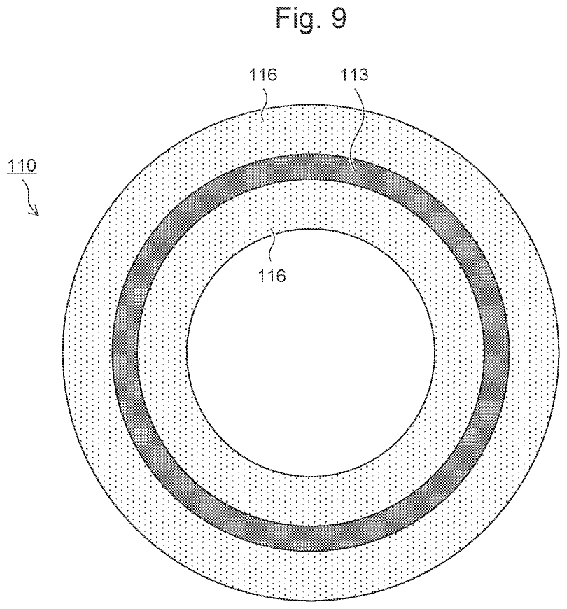

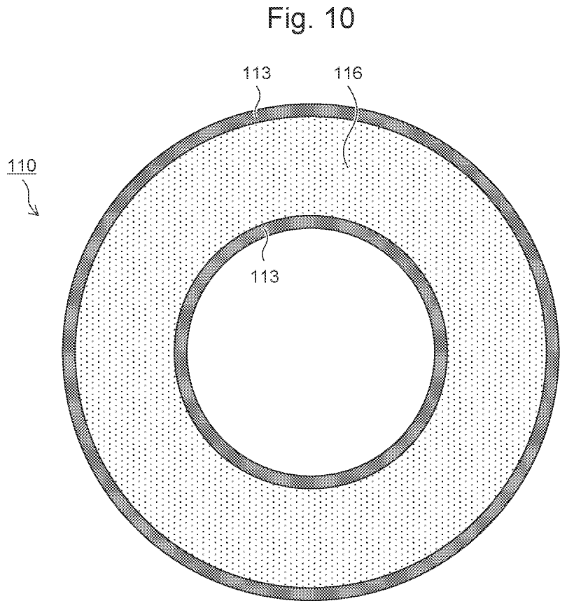

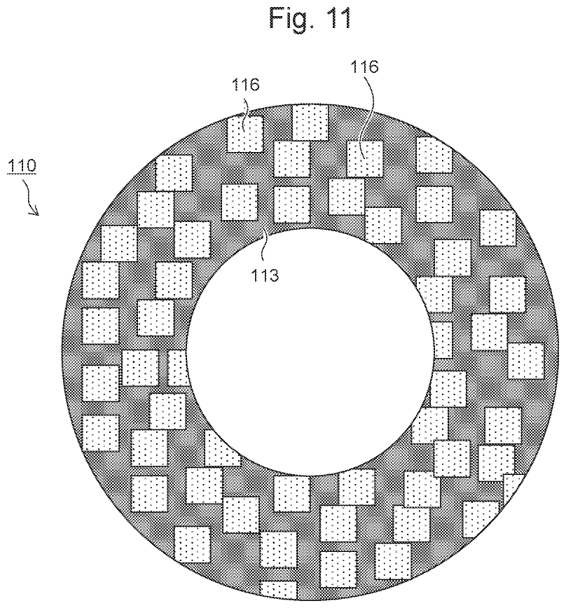

For example, the plurality of soft magnetic strips 10 only need to include at least one patterned soft magnetic strip 100, need not to include the unpattemed soft magnetic strip 200, and may include a plurality of the unpattemed soft magnetic strips 200. The order of laminating the plurality of soft magnetic strips 10 is not specifically limited as long as the gap 30 is formed between the adjacent soft magnetic strips 10. The numbers of the top surfaces 113 and the depressed surfaces 116 of the first surface 110 of the patterned soft magnetic strip 100 are not limited to the numbers described in the embodiments. For example, the first surface 110 of the patterned soft magnetic strip 100 may include a single top surface 113 and the plurality of depressed surfaces 116. FIG. 9 illustrates an example of such a patterned son magnetic strip 100. Alternatively, the patterned soft magnetic strip 100 may include the plurality of top surfaces 113 and a single depressed surface 116. FIG. 10 illustrates an example of such a patterned soft magnetic strip 100. In plan view in the laminating direction of the soft magnetic strips 10, the shapes of the top surface 113 and the depressed surface 116 of the patterned soft magnetic strip 100 are not limited to the partial circular ring shape or the circular ring shape described in the embodiments and may be any shape. In plan view in the laminating direction of the soft magnetic strips 10, the arrangements of the top surfaces 113 and the depressed surfaces 116 of the patterned soft magnetic strip 100 may be periodic or irregular. For example, as illustrated in FIG. 11, the patterned soft magnetic strip 100 may include the top surface 113 and the depressed surfaces 116, which are randomly arranged. Furthermore, when the laminated core 1 includes the plurality of patterned soft magnetic strips 100, in plan view in the laminating direction of the soft magnetic strips 10, the plurality of patterned soft magnetic strips 100 may include the top surfaces 113 having the same shape and arrangement and the depressed surfaces 116 having the same shape and arrangement, or may include the top surfaces 113 having different shapes and arrangements and the depressed surfaces 116 having different shapes and arrangements. These modifications may be used in any combination.

### EXAMPLE

The following specifically describes the present disclosure with the calculation examples, but the present disclosure is not limited to structures used in these calculation examples.

### Calculation Example 1

Eddy-current losses of laminated cores including five laminated soft magnetic strips having a circular ring shape as illustrated in FIGS. 1 to 4 were calculated using the magnetic circuit method described in Shigeru Konda et al., “Eddy current loss evaluation of magnetic powder core based on electric and magnetic networks”, AIP Advances 7, 056678 (2017).

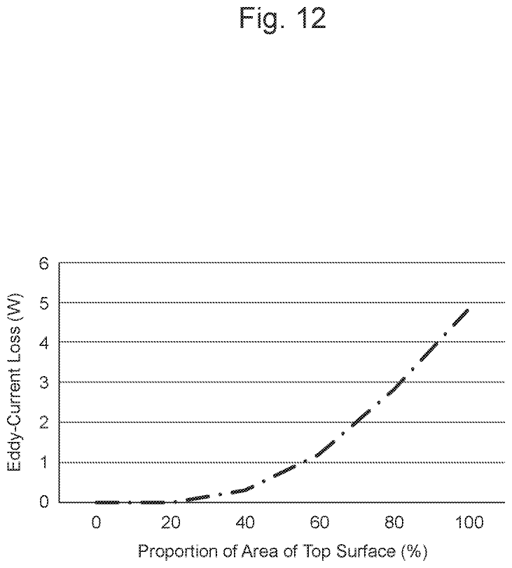

In the laminated core of Calculation Example 1, four of the five soft magnetic strips were patterned soft magnetic strips and one of the five soft magnetic strips was an unpatterned soft magnetic strip, and these soft magnetic strips were laminated in this order. A partial circular ring-shaped protruding portion with a top surface was disposed on a first surface of each of the patterned soft magnetic strips. The top surface had a partial circular ring shape and a part other than the top surface (depressed surface) of the first surface also had a partial circular ring shape. The top surface of the patterned soft magnetic strip contacted a surface of the adjacent soft magnetic strip opposed to the first surface of the patterned soft magnetic strip (specifically, a second surface of the adjacent patterned soft magnetic strip or a surface of the adjacent unpattemed soft magnetic strip). The depressed surface of the first surface did not contact the surface of the adjacent soft magnetic strip opposed to the first surface, and a gap was present between the depressed surface of the first surface and the surface of the adjacent soft magnetic strip opposed to the first surface. An area of the top surface was set to be 0 to 100% of an area of the first surface. Note that shapes and arrangements of the top surfaces in plan view in the laminating direction of the soft magnetic strips were the same in all of the patterned soft magnetic strips. Values of a resistivity, a thickness, a width, a length, and an outer diameter and an inner diameter of the soft magnetic strip, a resistivity and a height of the gap, a magnetic-flux density amplitude, and a magnetic-flux density frequency were as described in Table 1. In Table 1, the width means a distance between an outer periphery and an inner periphery of the soft magnetic strip, and the length means a perimeter of a circle intermediate between the outer periphery and the inner periphery of the soft magnetic strip, that is, an average of an outer peripheral length and an inner periphery length. FIG. 12 illustrates the calculation result. In FIG. 12, “Proportion of Area of Top Surface” means a proportion of an area of the top surface relative to the area of the first surface.

TABLE 1

| Soft Magnetic Strip | Resistivity (Ω · m) | 1 × 10⁻⁷ |
|---|---|---|
| | Thickness (μm) | 25 |
| | Width (mm) | 12.2 |
| | Length (mm) | 132.57521 |
| | Outer Diameter (mm) | 54.4 |
| | Inner Diameter (mm) | 30 |
| Gap | Resistivity (Ω · m) | 1 × 10¹⁴ |
| | Height (μm) | 0.1 |

| | |
|---|---|
| Magnetic-Flux Density Amplitude (T) | 1 |
| Magnetic-Flux Density Frequency (Hz) | 400 |

The results of Calculation Example 1 exhibited that the eddy-current loss was sufficiently reduced wen the top surface has the area of 20% or less of the area of the first surface.

### Calculation Example 2

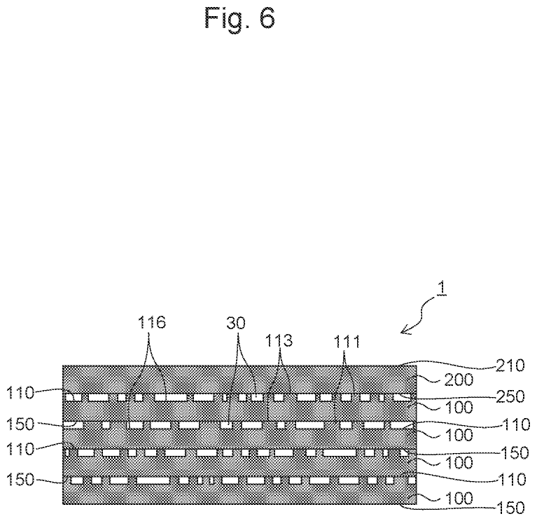

Eddy-current losses of laminated cores including five laminated soft magnetic strips having circular ring shapes as illustrated in FIG. 5 and FIG. 6 were calculated using the magnetic circuit method.

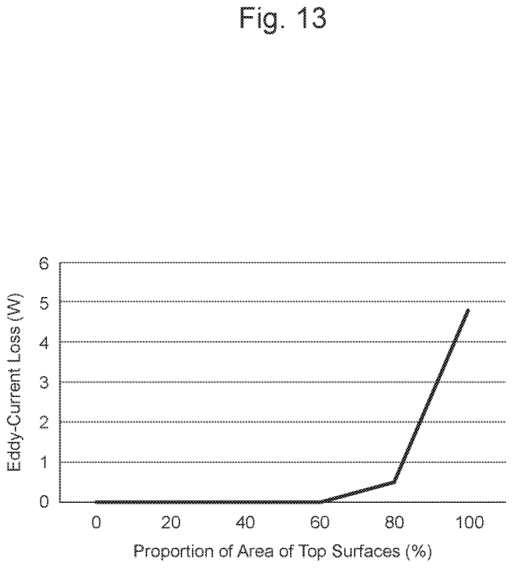

In the laminated core of Calculation Example 2, four of the five soft magnetic strips were patterned soft magnetic strips and one of the soft magnetic strips was an unpattemed soft magnetic strip, and these soft magnetic strips were laminated in this order. A plurality of protruding portions having a circular ring shape concentric with the soft magnetic strip and having top surfaces were disposed on the first surface of each of the patterned soft magnetic strips. Each top surface had a circular ring shape concentric with the soft magnetic strip. The depressed surfaces of the first surface each had a circular ring shape concentric with the soft magnetic strip. The top surfaces of each patterned soft magnetic strip contacted the surface of the adjacent soft magnetic strip opposed to the first surface of each patterned soft magnetic strip, specifically the second surface of the adjacent patterned soft magnetic strip or the surface of the adjacent unpatterned soft magnetic strip. The depressed surfaces of the first surface did not contact the surface of the adjacent soft magnetic strip opposed to the first surface, and gaps were present between the depressed surfaces of the first surface and the surface of the adjacent soft magnetic strip opposed to the first surface. In each of the four patterned soft magnetic strips, the total area of the plurality of top surfaces was set to be 0 to 100% of an area of the first surface. The numbers of protruding portions and inner diameters and outer diameters of the respective top surfaces were randomly set in the respective patterned soft magnetic strips. That is, arrangements of the top surfaces and the depressed surfaces in plan view in the laminating direction of the soft magnetic strips were different in all of the patterned soft magnetic strips. Values of a resistivity, a thickness, a width, a length, and an outer diameter and an inner diameter of the soft magnetic strip, a resistivity and a height of the gap, a magnetic-flux density amplitude, and a magnetic-flux density frequency were as described in Table 1. FIG. 13 illustrates the calculation result. In FIG. 13, “Proportion of Area of Top Surfaces” means a proportion of the total area of the plurality of top surfaces relative to the area of the first surface.

The result of Calculation Example 2 exhibited that the eddy-current loss was sufficiently reduced when the top surfaces have the total area of 60% or less of the area of the first surface. The total area of the depressed surfaces required to reduce the eddy-current loss in the laminated core including the plurality of randomly disposed protruding portions on the first surface as in Calculation Example 2 was smaller than that required reduce the eddy-current loss in the laminated core including a single protruding portion on the first surface as in Calculation Example 1. This result shows that by randomly disposing the plurality of protruding portions on the first surface, the eddy-current loss can be sufficiently reduced while the proportion of the gaps in the laminated core is reduced and a higher space factor is achieved.

### Calculation Example 3

Eddy-current losses of laminated cores including three laminated soft magnetic strips having circular ring shapes as illustrated in FIG. 7 and FIG. 8 were calculated using the magnetic circuit method.

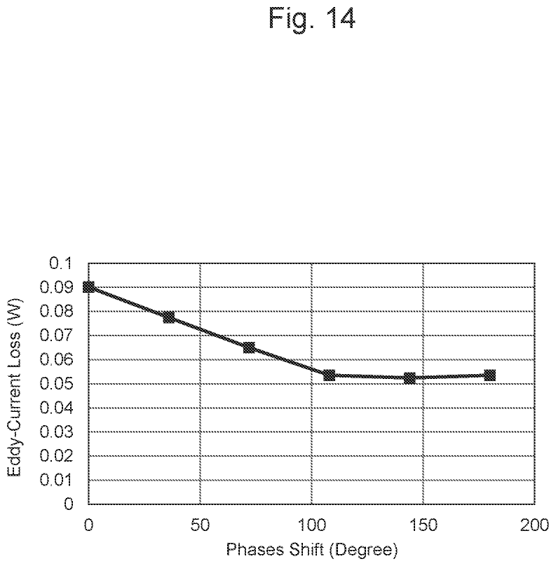

In the laminated core of Calculation Example 3, two of the three soft magnetic strips were patterned soft magnetic strips and one of the three soft magnetic strips was an unpattemed soft magnetic strip, and these soft magnetic strips were laminated in this order. Ten pieces of protruding portions having circular ring shapes concentric with the soft magnetic strip and having top surfaces were disposed on the first surface of each of the patterned soft magnetic strips. Each top surface had a circular ring shape concentric with the soft magnetic strip. The depressed surfaces of the first surface each had a circular ring shape concentric with the soft magnetic strip. The top surfaces of each patterned soft magnetic strip contacted the surface of the adjacent soft magnetic strip opposed to the first surface of each patterned soft magnetic strip, specifically the second surface of the adjacent patterned soft magnetic strip or the surface of the adjacent unpattemed soft magnetic strip. The depressed surfaces of the first surface did not contact the surface of the adjacent soft magnetic strip opposed to the first surface, and gaps were present between the depressed surfaces of the first surface and the surface of the adjacent soft magnetic strip opposed to the first surface. A width of each top surface was set to be 0.04 times a width of the soft magnetic strip. In the first surface of each patterned soft magnetic strip, 10 pieces of the protruding portions were regularly arranged between an inner edge and an outer edge of the soft magnetic strip at a pitch 0.1 times the width of the soft magnetic strip. In plan view in the laminating direction of the soft magnetic strips, phases of the protruding portions of the two patterned soft magnetic strips were shifted from one another by 0° to 180°. In each of the two patterned soft magnetic strips, the total area of the plurality of top surfaces was set to be 40% of the area of the first surface. Values of a resistivity, a thickness, a width, a length, and an outer diameter and an inner diameter of the soft magnetic strip, a resistivity and a height of the gap, a magnetic-flux density amplitude, and a magnetic-flux density frequency were as described in Table 1. FIG. 14 illustrates the calculation result.

The eddy-current loss was sufficiently reduced at the phase shift from 108° to 180°. Note that, with the phase shift from 108° to 180°, the total area of regions included in the top surfaces of one of the two patterned soft magnetic strips, the regions overlapping with the top surfaces of the other of the two patterned soft magnetic strips in plan view in the laminating direction of the soft magnetic strips, was 0 to 10% of the area of the first surface and 0 to 25% of the total area of the top surfaces of the first surface.

What is claimed is:

1. A laminated core comprising
a plurality of laminated soft magnetic strips,
wherein the plurality of soft magnetic strips include at least one patterned soft magnetic strip,
wherein the at least one patterned soft magnetic strip has a first surface, and the first surface includes at least one protruding portion having a top surface,
wherein the top surface of the at least one protruding portion contacts a surface opposed to the first surface, the surface opposed to the first surface being included in a surface of one of the plurality of soft magnetic strips, the one of the plurality of soft magnetic strips being adjacent to the at least one patterned soft magnetic strip, and
wherein a gap is present between the surface opposed to the first surface and a part of the first surface, the part being other than the top surface.

2. The laminated core according to claim 1,
wherein the at least one protruding portion includes a plurality of protruding portions, and the protruding portions has an total area of 60% or less of an area of the first surface.

3. The laminated core according to claim 1,
wherein the at least one protruding portion includes a single protruding portion, and the protruding portion has an area of 20% or less of an area of the first surface.

4. The laminated core according to claim 1,
wherein the at least one patterned soft magnetic strip includes two or more patterned soft magnetic strips, and
wherein in plan view in a laminating direction of the soft magnetic strips, the top surface of the at least one protruding portion in one of the patterned soft magnetic strips adjacent to one another includes a region overlapping with the top surface of the at least one protruding portion in another of the patterned soft magnetic strips adjacent to one another, the region having an area from 0 to 10% of an area of the first surface of the patterned soft magnetic strip.

5. The laminated core according to claim 1,
wherein the surface in contact with the top surface of the at least one protruding portion has an arithmetic mean surface roughness Sa 0.01 to 0.1 times a height of the top surface.
